(19) United States
(12) Patent Application Publication
(10) Pub. No.: US 2020/0251862 A1
(43) Pub. Date: Aug. 6, 2020

(54) ON-BOARD CHARGER

(71) Applicant: Q2Power AG, Ruggell (LI)

(72) Inventor: Michael Koch, Biberist (CH)

(21) Appl. No.: 15/999,527

(22) PCT Filed: Feb. 17, 2017
(86) PCT No.: PCT/CH2017/000015

§ 371 Date: Aug. 17, 2018

(30) Foreign Application Priority Data
Feb. 17, 2016 (CH) 00203/16

(51) Int. Cl. H01R 13/72; H02J 7/00

(52) U.S. Cl. CPC H01R 13/72; H02J 7/0042

(57) ABSTRACT

The invention relates to an on-board charger comprising a housing, a first electrode, a circuit board, a second electrode and a power output port; wherein the circuit board is located within the housing, the first electrode is telescopically arranged at the front end of the circuit board and protrudes beyond the housing from a front end opening of the housing, and the second electrode is electrically connected with the circuit board; and wherein the power output port is arranged at the center of a rear end of the housing. A plug is arranged laterally at the rear end of the housing and electrically connected with the second electrode.

### CROSS-REFERENCE TO RELATED APPLICATIONS

This application is a national phase entry under 35 U.S.C. § 371 of PCT/CH2017/000015 filed on Feb. 17, 2017, which claims priority to Swiss Patent Application No. 00203/16 filed on Feb. 16, 2016, the entirety of each of which is incorporated by this reference.

### FIELD OF THE INVENTION

The present invention relates to an automotive accessory, and particularly to an on-board charger.

### BACKGROUND OF THE INVENTION

With developments of science and technology, automobile has become a necessary transportation means in people's daily lives. Automobile leads to a convenient way of living, and thus significantly improves the quality of people's life. Meanwhile, electronic devices, such as mobile phones, tablets and MP3 players have been widely used in people's everyday lives. Such electronic devices need to be charged after a time of use. In order to facilitate charging of such electronic devices when people are riding on automobiles, on-board charger emerges in the market. An on-board charger is a device which obtains electricity from the automobile cigarette lighter, and then performs charging for terminal electronic devices like smart phones via an electric interface.

However, a conventional on-board is single-functioned and needs a connecting wire to connect to an electronic device such as a mobile phone.

### SUMMARY OF THE INVENTION

The present invention solves the problem that a conventional on-board charger is single-functioned and needs a connecting wire to connect to an electronic device such as a mobile phone.

To this end, the present invention provides an on-board charger, comprising a housing, a plug, a first electrode, a circuit board, a second electrode and a power output port;

wherein the circuit board is located within the housing, the first electrode is telescopically arranged at the front end of the circuit board and protrudes beyond the housing from a front end opening of the housing, and the second electrode is electrically connected with the circuit board; and wherein the power output port is arranged at the center of a rear end of the housing, and the plug is arranged laterally at the rear end of the housing and electrically connected with the second electrode.

In order to solve the above mentioned problem the plug is connected with the second electrode with a connecting wire and the on-board charger comprises a winding device to wind up the connecting wire on the rear end of the housing which winding device is realized by an outer cover arranged rotatable around the rear end of the housing. These features facilitate the use and storage thereof, and thus solves the problem of inconvenient usage and storage as the connecting wire of the on-board charger may be too long or too short. The present invention simplifies the configuration of the on-board charger through a novel design.

In one embodiment the winding device is unbiased and thus free from further elements such a pretensioned spring which elements would provide a force for winding up the connection wire. As the winding device comprises no further elements there are no elements present which could break. Hence the winding device is simple in its construction and usage and is very reliable.

In another embodiment, the plug is connected with the second electrode with a connecting wire, the connecting wire being wound on the rear end of the housing.

In yet another embodiment, the on-board charger comprises at least one power output port.

In still another embodiment, the on-board charger comprises two power output ports.

In another embodiment, the two power output ports are arranged in parallel.

In yet another embodiment, a function board is provided at the rear end of the housing, the power output port being provided on the function board.

In still another embodiment, the connecting wire is wound on the outer periphery of the function board, and an outer cover is arranged around a periphery of the function board, the outer cover being rotatable with respect to the function board.

In another embodiment, a notch is provided at the front end of the outer cover, the notch being able to cooperate with the plug.

In the on-board charger according to the present invention, a power output port which needs a connecting wire for connection and a plug which does not need a connecting wire for connection are provided, achieving the multifunction of the on-board charger. With the plug, it is no longer necessary to use a connecting wire for charging of an electronic device like a mobile phone, which contributes to convenient usage of the on-board charger.

Further, the connecting wire connected with the plug is wound tidily on the rear end of the housing, which facilitates use and storage thereof, and thus solves the problem of inconvenient usage and storage as the connecting wire of the on-board charger may be too long or too short. The present invention is novel in design and convenient to use.

Further, a functional board is provided at the rear end of the housing and the power output port is provided on the function board. The on-board charger of the present invention may have a plurality of power output ports, which improves adaptability of the on-board charger of the present invention, compared with the on-board charger commercially available having only one power output port.

### BRIEF DESCRIPTION OF THE DRAWINGS

FIG. 1 is an exploded view of an on-board charger according to a first embodiment of the present invention;

FIG. 2 is a structural view of an on-board charger according to the first embodiment of the present invention in an assembled state;

FIG. 3 is a structural view of an on-board charger according to a second embodiment of the present invention in an assembled state.

### DETAILED DESCRIPTION OF ILLUSTRATED EMBODIMENTS

Embodiments of the present invention will be described below in detail with reference to the drawings. The embodiments described below are illustrative of the present invention and are not limiting the scope of the present invention.

### The First Embodiment

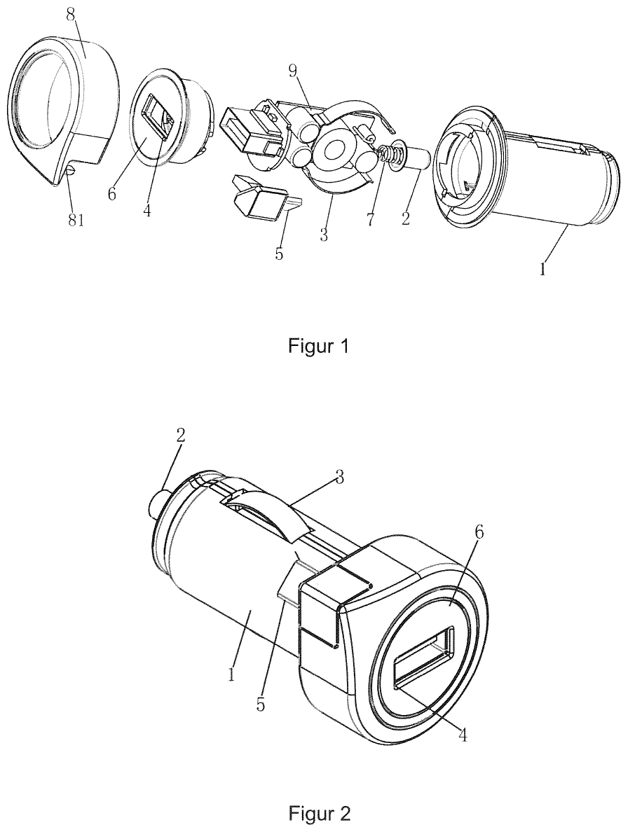

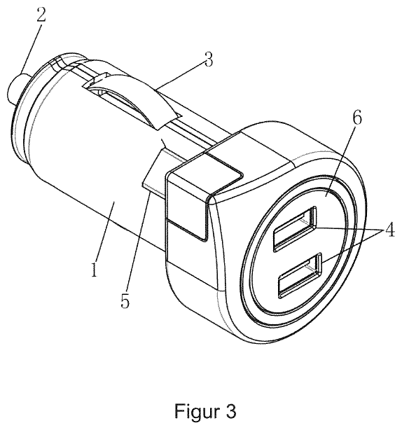

As illustrated in FIGS. 1 and 2 (where a connecting wire is not shown), an on-board charger according to the present invention comprises a housing 1, a connecting wire, a plug 5, a first electrode 2, a circuit board 9, a second electrode 3 and a power output port 4. The housing 1 of this embodiment consists of a first half housing and a second half housing, the first half housing and the second half housing being able to fit together to form a cavity with an opening at each end thereof, thus facilitates manufacturing and assembly/disassembly. The circuit board 9 is located within the cavity of the housing 1. The first electrode 2 is arranged at a front end of the circuit board 9, and protrudes beyond the housing 1 from a front end opening of the housing 1. The power output port 4 is arranged at the center of a rear end of the housing 1. The second electrode 3 is located at a peripheral wall of the housing and is electrically connected with the circuit board 9. A via hole is provided where the first half housing and the second half housing fit together, the second electrode 3 being arranged within the via hole where the first half housing and the second half housing fit together.

The power output port 4 may be a USB interface or a power connector, and the first electrode 2 and the second electrode 3 represent an anode and a cathode, respectively. The first electrode 2 is an anode and the second electrode 3 is a cathode. The first electrode 2 is in a form of an electrode cap and the second electrode 3 is in a form of an electrode slice, which facilitates the mounting thereof. In this embodiment, there is only one power output port 4.

The connecting wire is at one end electrically connected to the second electrode 3 and at the other end electrically connected to the plug 5. Generally, the connecting wire is wound on the rear end of the housing. In use, it is only necessary to hold the plug 5, and pull the connecting wire wound on the housing 1 to an appropriate length. After use, it is then only necessary to wind the connecting wire on the housing 1. In this embodiment, the connecting line is wound tidily on the housing 1, which facilitates use and storage thereof, and thus solves the problem of inconvenient usage and storage as the connecting wire of the on-board charger may be too long or too short. The present invention simplifies the configuration of the on-board charger through a novel design.

In the on-board charger of this embodiment, a function board 6 is provided at the rear end of the housing. The power output port 4 is provided on the function board 6, and the connecting wire is wound on the outer periphery of the function board 6. Additionally, an outer cover 8 is arranged around a periphery of the function board 6. The outer cover 8 is rotatable with respect to the function board 6, and is provided with a notch 81 at a front end thereof, which may cooperate with the plug 5. When the connecting wire is wound on the function board 6, the plug 5 is stuck in the notch 81. This design achieves certain aesthetic effect. That is, when the connecting wire is in a wound up state, the plug 5 and the notch 81 contribute to a complete lateral wall of the outer cover 8.

In this embodiment, the on-board charger further comprises a spring 7, the two ends of which abut against the first electrode 2 and the circuit board 9, respectively, thereby achieving telescoping and automatic return of the first electrode 2.

### The Second Embodiment

As illustrated in FIG. 3, the only difference between the on-board charger of this embodiment and that of the first embodiment lies in that, the on-board charger of this embodiment has two power output ports 4, which are arranged in parallel on the function board 6. Depending on actual conditions, the on-board charger of this embodiment may have three or more power output ports 4. With this design, a plurality of electronic devices may be charged simultaneously, which improves adaptability of the on-board charger.

Apart from the above-mentioned difference, the on-board charger of this embodiment is identical with that of the first embodiment.

### The Third Embodiment

The only difference between the on-board charger of this embodiment and that of the first embodiment lies in that, the plug of the on-board charger of this embodiment clamped laterally at the rear end of the housing and is directly electrically connected with the second electrode without a need of a connecting wire. Thus, the on-board charger is simpler in structure and lower in cost.

While various embodiments of the present invention have been described above, it should be noted that, for one skilled in the art, various modifications and substitutes are possible without departing from the concept of the present invention, which modifications and substitutes are interpreted to fall within the protection scope of the present invention.

1. An on-board charger, comprising:
a housing;
a first electrode, a circuit board, a second electrode, at least one power output port and a plug arranged laterally at a rear end of the housing and electrically connected with the second electrode;
wherein the circuit board is located within the housing, the first electrode is telescopically arranged at the front end of the circuit board and protrudes beyond the housing from a front end opening of the housing, and the second electrode is electrically connected with the circuit board; and
wherein the at least one power output port is arranged at the center of a rear end of the housing and the plug is connected with the second electrode with a connecting wire and the on-board charger comprises a winding device to wind up the connecting wire on the rear end of the housing which winding device comprises an outer cover rotatable about the rear end of the housing.

2. The on-board charger as claimed in claim 1, wherein the winding device is unbiased.

3. The on-board charger as claimed in claim 1, wherein the on-board charger comprises a plurality of power output ports.

4. The on-board charger as claimed in claim 1, wherein the on-board charger comprises two power output ports.

5. The on-board charger as claimed in claim 4, wherein the two power output ports are arranged in parallel.

6. The on-board charger as claimed in claim 2, further comprising a function board at the rear end of the housing, the power output port provided on the function board.

7. The on-board charger as claimed in claim 6, wherein the connecting wire is wound on the outer periphery of the function board, and the outer cover is arranged around a periphery of the function board, the outer cover being rotatable with respect to the function board.

8. The on-board charger as claimed in claim 7, further comprising a notch is provided at the front end of the outer cover, the notch able to cooperate with the plug.
